(19) United States
(12) Patent Application Publication
(10) Pub. No.: US 2005/0051128 A1
(43) Pub. Date: Mar. 10, 2005

(54) Piston structure for reducing friction losses

(76) Inventor: Min Jeong Kim, Seoul (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/751,027

(22) Filed: Dec. 31, 2003

(30) Foreign Application Priority Data
Sep. 9, 2003 (KR) 2003-63148

(51) Int. Cl. F02F 3/00

(52) U.S. Cl. 123/193.6

(57) ABSTRACT

The present invention relates to a piston for decreasing a frictional losses by receiving a part of the expanding gas during the power stroke of an engine and reducing contact pressure on a piston applied from the expanding gas, thereby enhancing fuel consumption and engine power. The piston for decreasing such friction includes a recess for receiving expanding gas formed in a circumferential section of a top land part of the piston head.

### CROSS-REFERENCE TO RELATED APPLICATIONS

This application claims priority of Korean Application No. 10-2003-0063148, filed on Sep. 9, 2003, the disclosure of which is incorporated fully herein by reference.

### FIELD OF THE INVENTION

The present invention relates to a piston structure and, more particularly, to a piston structure that reduces frictional losses in the engine.

### BACKGROUND OF THE INVENTION

Recent increase in fuel price and more strictly reinforced regulations against exhaust gas emitted by a vehicle has led to development of new technology related to low fuel consumption and low emissions, etc.

In particular, when friction loss in an engine is decreased, heat efficiency of the engine is increased. Therefore, the distance that a vehicle can run per unit amount of fuel is increased. The amount of fuel used for achieving the same performance is decreased, thereby decreasing an air pollution.

Therefore, the decrease in friction loss in an engine is important for developing a vehicle having a low fuel consumption rate and low emissions, etc.

Friction loss occurring in a piston system occupies 10-15% of the total friction loss of an internal combustion engine, so that a decrease of a friction loss in the above system can contribute to enhancing engine efficiency.

During the power stroke of an engine, contact pressure between the piston and cylinder is increased. If a contact pressure exceeds a critical level, a seizure may occur in a skirt part of the piston and a scratch may occur in the cylinder. Friction force between the piston and cylinder has a relationship with lateral force applied to the cylinder. The lateral force of the piston may be obtained based on the total force applied to the piston and the angle of a connecting rod connected with the crankshaft. For example, a horizontal direction force of the connecting rod is a lateral force of the piston, and the total force applied to the piston is a sum of a consumption pressure applied to the top of the piston and an inertial force of the piston. Decreasing the friction based on the lateral force of the piston largely affects enhancement of the efficiency of an engine.

Generally, for decreasing a friction of a piston system, according to the Japanese patent laid-open Sho 54-89115, there is provided an offset crankshaft method. The disclosed method is directed to decreasing lateral force on a piston by decreasing the operation angle of the connecting rod when inner pressure of the cylinder is maximized in such a manner that the center of the bore of the cylinder is not matched with the center of the crankshaft (namely, an eccentric state).

In the above prior art method, in the compression stroke, lateral force is increased, but lateral force is decreased more in the intake stroke and the power stroke, so that the friction is decreased.

The offset crankshaft is more effective in the low speed and low load region.

In another method for decreasing a friction of a piston system, according to the Japanese patent laid-open Nos. 2000-97338 and Hei 9-119523, there is provided a method for decreasing an inertial force of the piston. Although there is little effect in decreasing inertia of a piston by decreasing the weight of the piston system, there is a certain limit for decreasing friction by decreasing the weight because the piston is required to have a certain minimum weight.

### SUMMARY OF THE INVENTION

Embodiments of the present invention provide a piston for an internal combustion engine, which is capable of decreasing frictional losses and enhancing the fuel consumption rate and an engine power by reducing contact pressure of a piston applied during the power stroke. In addition, durability of the piston and cylinder and/or liner are improved.

In an embodiment of the present invention, a piston comprises a piston head defining a recess for receiving expanding gas, which recess is formed at a circumferential section of a top land part of the piston. A part of the expanding gas flows into the recess during the power stroke of the internal combustion engine.

In a preferred embodiment of the present invention, the recess for receiving an expanding gas is formed over at least substantially ¼ circumferential section in the entire circumference of a top land part of the piston head. Further, the recess is deepest at an intermediate portion of the entire recess section, and the depth of the recess becomes shallower in the direction of both end sides of the recess.

Preferably, the recess has both ends getting wider in an upper direction in a slanted line shape.

In a further preferred embodiment of the present invention, at least two recesses are formed at a symmetrical portion with respect to the axial line of the piston.

In another further embodiment of the present invention, a piston structure for reducing frictional losses in an internal combustion engine comprises a piston head having a top land portion. The first and second recesses are symmetrically formed in the top land portion on opposite sides of the piston head, The recesses are formed by a vertical cut-away of a portion of the top land portion. Each cut-away comprises approximately ¼ of the top land portion in a circumferential direction

### BRIEF DESCRIPTION OF THE DRAWINGS

The aforementioned aspects and other features of the present invention will be explained in the following description, taken in conjunction with the accompanying drawings, wherein:

FIG. 1 is a perspective view illustrating the construction of a piston according to the present invention;

FIG. 2 is a cross sectional view taken along the line A-A of FIG. 1; and

FIG. 3 illustrates a simulation of a driving state during the power stroke of a piston according to an embodiment of the present invention.

### DETAILED DESCRIPTION OF THE PREFERRED EMBODIMENTS

Hereinafter, such embodiments of the present invention are described in detail with reference to the accompanying drawings.

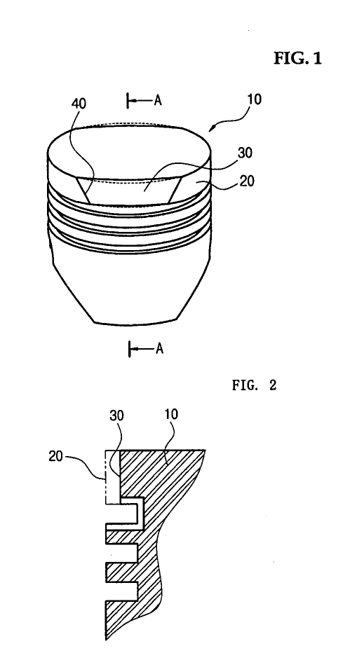

As shown in FIG. 1, piston head 10 defines a recess 30 having a certain depth that is formed in a thrust side of the piston head 10. Preferably is in a top land part 20, over a circumferential section. Recess 30 receives expanding gas generated due to the explosion in the power stroke of an internal combustion engine. Therefore, a piston according to a preferred embodiment is not affected by gas pressure corresponding to the level of the expanding gas flowing into the recess 30, so that it is possible to reduce a contact pressure of the piston head 10.

The recess 30 is preferably formed over at least a one-fourth circumferential section of the entire circumferential section of the top land part 20. It is preferably formed at two portions symmetrical with respect to the vertical center axial line of the piston head 10. More preferably, it is symmetrically formed at both sides of the offset axial line of the piston pin (not shown).

As shown in FIG. 2, recess 30 has the deepest depth at the intermediate portion in the entire recessed section. The depth gets gradually shallow in the direction of both sides of the deepest intermediate portion. In addition, the both ends of recess 30 become wider in the direction of the upper side in a slanted line shape for guiding the expanding gas in the direction of the center of the thrust side.

In particular, the depth and size of the recession 30 for receiving an expanding gas may be adjusted in accordance with a dimension of the piston head 10. It is preferred to configure the optimum depth and size of the recess 30 based on empirical data.

If the depth of recess 30 is out too large, a dead volume occurs, so that it is preferred to set the depth and size within a range obtained through repeated tests.

Recess 30 receives a part of the expanding gas during the power stroke, and the contact pressure with the piston head 10 is reduced. The expanding gas produced in the stroke portion in which the piston head 10 is moved from the top dead center to the bottom dead center, namely, in the portion of the power stroke in which gas is forced into recess 30, piston head 10 is not affected by the discharged, expanding gas for thereby performing a power stroke.

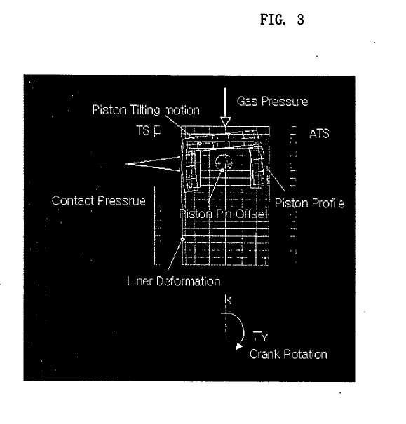

As shown in FIG. 3, during the power stroke, since the piston head 10 is not affected by a part of the expanding gas forced into recess 30, it is possible to decrease the contact pressure of the piston head 10 and minimize the decrease in efficiency in the piston system. Therefore, it is possible to enhance a fuel consumption rate and an engine power based on lower piston frictional losses, and the durability of the piston and cylinder is enhanced.

As described above, in the present invention, a part of the expanding gas is used for decreasing a friction of the piston during the power stroke of the engine. Therefore, the fuel consumption rate and the engine power are enhanced, and the durability of the piston and cylinder is enhanced.

1. A piston capable of reducing friction, comprising a piston head defining a recess for receiving expanding gas, which is formed in a circumferential section of a top land part of the piston head, the recess being configured such that a part of the expanding gas is introduced into the recess during a power stroke of an internal combustion engine.

2. The piston according to claim 1, wherein said recess is formed over at least substantially ¼ of a circumferential section in an entire circumference of the top land part of the piston head.

3. The piston according to claim 1, wherein said recess is deepest at an intermediate portion of the recess, and the depth of the recess becomes shallower towards ends of the recess.

4. The piston according to claim 1, wherein said recess has ends getting wider in an upper direction in a slanted line shape.

5. The piston according to claim 1, wherein at least two recesses for receiving an expanding gas are formed at a symmetrical portion with respect to an axial line of the piston head.

6. A piston structure for reducing frictional losses in an internal combustion engine, comprising a piston head having a top land portion wherein first and second recesses are symmetrically formed in said top land portion on opposite sides of said piston head, said recesses being formed by a vertical cut-away of a portion of said top land portion.

7. The piston structure of claim 6, wherein each said cut-away comprises approximately ¼ of the top land portion in a circumferential direction.
